(19) United States
(12) Patent Application Publication
(10) Pub. No.: US 2025/0126109 A1
(43) Pub. Date: Apr. 17, 2025

(54) METHOD FOR THE SECURE PROVISION OF A SERVICE THROUGH A CENTRAL PROVISION ENTITY AND DEVICE

(71) Applicant: SIEMENS AKTIENGESELLSCHAFT, München (DE)

(72) Inventors: Jochen Balduf, Hambrücken (DE); Harald Albrecht, Nürnberg (DE); Frank Volkmann, Nürnberg (DE)

(21) Appl. No.: 18/730,304

(22) PCT Filed: Jan. 10, 2023
(86) PCT No.: PCT/EP2023/050436

§ 371 Date: Jul. 18, 2024

(30) Foreign Application Priority Data
Jan. 19, 2022 (EP) 22152226.1

(51) Int. Cl. H04L 9/40; G06F 21/10

(52) U.S. Cl. CPC H04L 63/0823; G06F 21/1084; H04L 63/166

(57) ABSTRACT

The participants in the Industrial Edge ecosystem want extensive automatic integration mechanisms, if possible without interfering with currently common OPC UA software stacks. The OPC UA server applications cannot however be externally accessed without further measures so that the user has to balance the server ports between the application view and the edge device view and must in the process consider port conflicts and compliance with possible network environment restrictions, as well as the other parts of its automation application with the servers via the concrete network addressing information. It is proposed to produce an initial trust relationship (with a “certificate of origin”). This certificate of origin/initial trust relationship corresponds to the CA certificate of the provision entity. In addition, it is proposed to expand a combination of “proxy plus local directory service (Local Discovery Server,

This application is the National Stage of International Application No. PCT/EP2023/050436, filed Jan. 10, 2023, which claims the benefit of European Patent Application No. EP 22152226.1, filed Jan. 19, 2022. The entire contents of these documents are hereby incorporated herein by reference.

### BACKGROUND

Industrial automation systems may include a large number of automation devices networked together via an industrial communication network and are used as part of a production or process automation system for controlling or regulating plants, machines, or devices. Due to time-critical constraints in industrial automation systems, real-time communication protocols such as PROFINET, PROFIBUS, Real-Time Ethernet, or Time-Sensitive Networking (TSN) are predominantly used for communication between automation devices. For example, control services or applications may be distributed automatically over currently available servers or virtualized environments of an industrial automation system on a load-dependent basis.

Disruptions in communication links between computer units of an industrial automation system or automation devices may result in undesirable or unnecessary repetition of the transmission of a service request. In addition, messages that have not been or not completely transmitted may prevent an industrial automation system from transferring to or remaining in a safe operating state, for example.

Problems may arise in Ethernet-based communication networks when network resources are taken up for the transmission of data streams or data frames with real-time requirements competing for the transmission of data frames with large user data content without specific service-level requirements. This may result in data streams or data frames with real-time requirements not being transmitted according to the requested or required quality of service.

Edge technology allows, for example, automation users to easily install, update, and extend the functionalities the automation users want for their automation in a modular fashion, in the form of applications. Users benefit both from centralized and easily scalable management of many devices, also referred to in the following as Industrial Edge devices, as well as those from the market, which also includes third-party providers of these applications. Another important aspect is the desire of automation users to be able to install applications from different vendors as simply as possible and use the applications immediately without additional integration effort.

In the field of automation technology, OPC Unified Architecture (OPC UA) (e.g., www.opcfoundation.org) has established itself for semantically high-quality and secure data exchange. Application providers increase the attractiveness of their applications by providing, for example, the data calculated by the applications from a production data analysis, image analysis, etc. to other automation functions via an integrated OPC UA server. Compared to the classical device world, users now have to integrate not only a classical device-OPC server into the same device (e.g., Industrial Edge device), but also multiple applications with OPC UA server functionality from different providers (e.g., third-party).

Workflow control components are, for example, software containers that each run in isolation from other software containers or container groups within the workflow control environment on a host operating system of a server device. In principle, alternative micro-virtualization concepts, such as Snaps, may also be used for the workflow control components.

For example, the workflow control environment may include a Docker engine or Snap core running on a server device. In one embodiment, the software containers, together with other software containers running on the respective server device, use a kernel of the host operating system of the server device. For example, memory images for the software containers may be retrieved from a storage and provisioning system to which a large number of users have read and/or write access.

Users of such control applications for industrial automation systems, realized by, for example, container virtualization or comparable virtualization concepts, also expect the most straightforward possible integration of these applications into their existing infrastructure.

If an OPC UA server application is executed in a virtualization solution such as a (Docker) container, then the application is initially free in the network resources it occupies, such as TCP ports in particular (e.g., port 4840 is predefined for a single server, such as in OPC UA).

Manual integration, as in the previous world of individual devices, is too complex and error-prone in the industrial environment and, in some cases, even impossible due to the lack of configuration points in the OPC UA servers. This integration includes not only the applications in the device but also the interaction of device-external components of the automation applications with the device applications.

Depending on the network connection and the workflow control environment used, OPC UA servers, for example, encounter widely varying user-side configurations that are to be taken into account by control applications developers in automated configuration procedures for the control applications. For the network connection, the user faces particular challenges when integrating control applications into an existing infrastructure due to scarce IP address and TCP port number ranges. The use of private port numbers also leads to diversity in the network infrastructure (e.g., the manual activation of the ports in firewalls).

However, the OPC UA server applications cannot be accessed externally without further measures. This provides that the user is to balance the server ports between the application view and the Edge device view and in doing so pay attention to port conflicts and provide compliance with possible restrictions in the network environment (e.g., how to use the limited number of ports that may be enabled in firewalls and their specific value ranges or preset default rules without further (configuration) effort).

In addition, the automation engineer is to link the other parts of their automation application to the servers via the specific network addressing information.

This provides that a developer is to select and specify the address information (e.g., port) even before the subsequent use of the application is known. As a result, a complex reconfiguration is to be carried out during commissioning.

### Prior Art

Users and developers for modular installations of server applications in automation systems want secure communication that goes beyond the pure connectivity between clients and servers (e.g., in accordance with the OPC UA standard). The secure communication is to be as simple as possible to set up and operate and, above all, with as little additional effort and expert knowledge as possible. In addition, more than one individual UA server is to be supported. The subscribers to the Industrial Edge ecosystem are therefore seeking largely automatic integration mechanisms (e.g., without intervention in commonly used OPC UA software stacks).

For the methods described below, it is a prerequisite that servers (e.g., OPC UA servers) on an Industrial Edge/container system may be discovered and accessed by clients (e.g., via an intelligent proxy).

To provide the required secure deployment, a suitable certificate is required. Without further action, a connection attempt (e.g., via the proxy to an internal server) will be terminated by the OPC UA client during verification of the server certificate because the addressing information entered in the certificate, valid within the subnet, also referred to as “inner” or internal endpoint address(es) (e.g., EndpointURIs, Uniform Resource Identifier), of the server does not match the EndpointURIs visible to the clients (e.g., and “outer” or external EndpointURIs created by the proxy).

An OPC UA proxy, for example, acts in the same way as web proxies (e.g., Ingress) by forwarding the incoming connections on a common network port based on additional criteria at the level of the OPC UA application layer (e.g., from the point of view of the ISO/OSI layer model).

The proxy is to manipulate the endpoint addresses (e.g., EndpointURIs) of the OPC UA server apps/instances as soon as more than one server has been activated or if the external IP or DNS name of the host is unknown or may change dynamically.

The generation/use of self-signed certificates with the “wrong” network parameters (e.g., hostname/IP and port) by the server is a system-related characteristic of common virtualization solutions (e.g., containers), since only these are known to the OPC UA server.

Rejection of the server certificate by the client is therefore a fundamental problem of common virtualization solutions (e.g., containers), since a server (e.g., OPC UA server) running in it only ever knows its internal network parameters (e.g., hostname/IP and port) of the virtual network. However, these do not match the network parameters of the host system accessible to the client.

Up to now, this has led to the difficulty that developers of server applications (e.g., OPC UA) are to provide suitable additional configuration mechanisms, and industrial users are to manually create the required server certificates suitable for establishing the connection and install the required server certificates in the individual server applications (e.g., OPC UA) when commissioning Industrial Edge devices and their server applications (e.g., OPC UA).

Users and application developers therefore would like automated processing of the steps in order to obtain a system that runs securely as quickly and effortlessly as possible. Such solutions are currently not covered by the well-known OPC UA standards.

In addition, application developers want to consider as few (e.g., no) special precautions for their Industrial Edge containers as possible (e.g., an out-of-the-box solution).

In order for the server to receive a valid certificate, at present, the user is first to manually create a certificate with the specific endpoint information (e.g., EndpointURIs) of the host system. These are not known for certain until operation starts. In a second act, the certificate is to be loaded onto the server (e.g., OPC UA), where this loading depends on the respective server (e.g., OPC UA) and its loading mechanism.

An automated process cannot be used for this, as the underlying “Certificate Signing Request” (CSR) of the OPC UA server from a certificate server likewise only uses the internal network parameters.

In an earlier application, “Method, computer program product and device for generating a certificate for the secure provision of services,” a method in the form of a combination consisting of a proxy, a local directory service (Local Discovery Server, LDS) and a directory service (Global Discovery Service, GDS) that allows a plurality of OPC UA servers on an Industrial Edge or container system to be securely accessed by OPC UA clients via a common port (e.g., the notorious 4840) and configured with valid certificates is described.

For the mechanism described here, it is necessary that the OPC UA servers contain an authentication that the directory service GDS accepts as authority for the initial distribution of the certificates (e.g., enrollment) (cf. Standard OPC 10000-12-Part 12: Discovery and Global Services).

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a secure provision of services by automated creation and secure distribution of suitable certificates is provided.

The embodiments in the description of the figures are to be understood as examples only and should not be read as restrictive of the scope of protection.

The authentication mentioned above is currently a manually performed step. Proof of authentication, known to the person skilled in the art as credentials (also known as login data or login information), is to be configured for an identity that has the authority to configure certificate material.

The provision (known as “deployment”) of the initial credentials (e.g., username/password, security token, certificate, etc.) currently always requires manual configuration, usually by a configuration tool. In the prior art, this is, for example, editing a security configuration file and then uploading the security configuration file, either into a deployment management system or into the already running application (e.g., unsecured).

These credentials may be configured, for example, via the application management of the Edge infrastructure. If authentication is to be obtained by a certificate (e.g., and thus presumably to be automated), this results in a classic “chicken-and-egg” problem.

It is therefore provided to establish an initial trust relationship (e.g., with a “certificate of origin”). This certificate of origin/initial trust relationship corresponds to the Certificate Authority (CA) certificate of the provision entity.

As a further way of solving this problem, it is additionally proposed to extend a combination of Proxy plus local directory service (Local Discovery Server, LDS) plus internal directory service (Global Discovery Service, GDS) (140) to include an internal registry entity, or registrar. Technically, for example, the registrar may be a supplement to the internal directory service server IGDS.

### BRIEF DESCRIPTION OF THE DRAWINGS

FIG. 1 shows an overview of a system according to an embodiment;

FIG. 2 shows an extension of the system illustrated in FIG. 1 with supplementary license information;

FIG. 3 shows a standard communication sequence for contact between server and client; and

FIGS. 4 and 5 show a supplement to FIG. 1 with a plurality of applications on the device.

### DETAILED DESCRIPTION

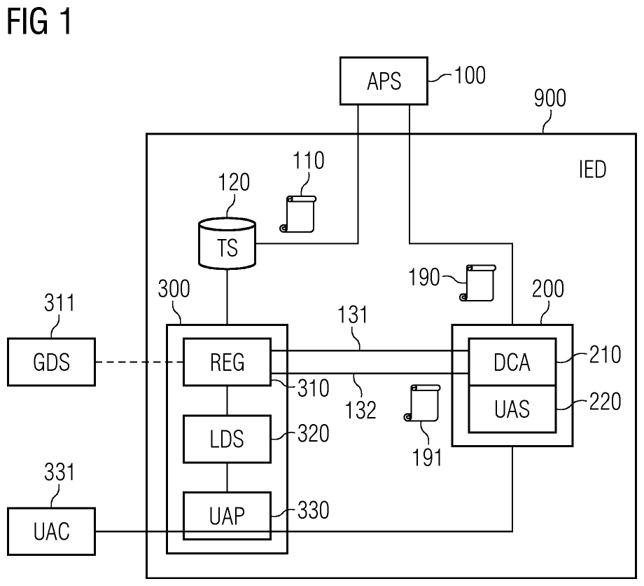

Two tasks of the Device Provisioning described in OPC Foundation Part 211 are explained in more detail using the described method, as also set out in detail in FIG. 1.

### Task 1

A deployment entity “Application Store” APS, 100, via which the service provider application entity, OPC UA Server UAS, 220, is centrally offered and distributed, becomes the “manufacturer” of the application instance 200 in the context of Device Provisioning. The application instance is treated in this case in the same way as a physical device (e.g., “hardware device”). In this manufacturer role, the provision entity 100 generates a service certificate, 190 and a matching device certificate, such as an IEEE 802.1AR Initial Device Identifier iDevID, 110, or 1DevID (locally significant Device Identifier) for the application entity.

The iDevID is used to authorize the application/registrar. If this is successful, the registrar will optionally issue the matching DCA certificate or an Application Instance Certificate (AIC, a communication certificate issued once only to the application instance) and transport the matching DCA certificate or the Application Instance Certificate to the application. The matching DCA certificate or the Application Instance Certificate is then used by the client to establish a subsequent connection (e.g., contains the correct address data).

In an embodiment, the device certificates 110 that are assigned to a device IED, 900 may be stored on the device in a dedicated device certificate store TS, 120. The certificate is inseparably connected/linked/interwoven with the application by common cryptographic methods such that the application technically becomes a “one-off” and thus biunique instance. This instance is represented by a biunique ProductInstanceURI. It is generated by the provision entity and is part of the service certificate 190 and of the device certificate 110. The cryptographic process also provides that the private key contained in the service certificate is unreadable. The transport of this application instance from the provision entity to the device is to be secured via secure communication (e.g., Transport Layer Security (TLS)).

The device certificate 110 is transferred to the internal registry instance REG 310, which may be part of the directory service IGDS of the OPC UA LDS proxy 300. The proxy 330 is also another application on the device.

### Task 2

The runtime environment on the device IED, 900 (e.g., and the proxy/IGDS 300) in the context of Device Provisioning become “operators” that want to install and commission the application: in order that the directory service IGDS 300 may transfer certificates into the OPC UA application UAS, 220 (e.g., via a push procedure), the Device Provisioning procedure is carried out between the registrar 310 and the application 200 (e.g., corresponds to the role “Device”).

During the device provisioning, the service certificate (190) and the device certificate (110) are used to identify the device (e.g., the application (200)) to the central registry instance REG. The method is now used, contrary to the Device Provisioning described in OPC Foundation Part 21, in the reverse direction: the IGDS 310, which acts as an internal registry instance, identifies itself to the application 200, 131 and thus receives the authority to transfer a communication certificate to the application, 132. This may be done without changing the method because device provisioning always involves a mutual identification due to the procedure used. However, this fact that the internal registry instance (e.g., as part of the IGDS, 310) identifies itself to the device (e.g., the service/application, 200) is not considered further in the device provisioning case and has no effect on this method. Compared to the prior art, the trust relationship established, by Device Provisioning described in OPC Foundation Part 21, is therefore used in reverse.

By the combination “Proxy+LDS+IGDS+internal registry entity” 140, it is possible not only to make the internal OPC UA server UAS, 220 instances accessible for a client UAC via a common port 303 but also to fill the internal OPC UA server UAS, 220 instances with valid communication certificates fully automatically so that a Secure Channel/Communication 600 connection may be set up.

The software application (e.g., the Docker container) is considered as a hardware device and in an optional embodiment may be provided with an instance identification DCA, 210 in exactly the same way as a hardware device.

As soon as the DCA certificate is issued, the iDevID (e.g., device instance certificate) is no longer used.

The sequence is therefore: 1. The iDevID is “interwoven” into the application when the application is purchased; 2. the iDevID is used to establish the trust relationship between the application and registrar; 3. the registrar sends a DCA certificate to the application; 4. the application uses the DCA certificate to request an AIC certificate from the registrar; 5. the registrar sends the AIC certificate to the application, which now, for example, contains the correct external addresses; 6. a client may connect via the proxy and “sees” the AIC with the correct addresses.

The DCA is used in OPC UA Part 21 to request additional AICs. Since this is not required here, acts 3 and 4 may coincide in our case by the registrar sending the correct AIC directly.

This instance identification (e.g., which is now only software-based) is used in conjunction with the device certificate 110 so that the Application Instance Certificate (AIC, 132) to be used productively may be deployed without further manual authorization steps needing to be carried out.

The following constraints are to be taken into account: In the known provisioning methods (e.g., device provisioning), it is fundamental that the service certificate 190 (e.g., the private key contained in the service certificate 190) is protected against readout (cf., Secure Elements). In the case of the proposed adaptation of the method to the software procedure, this is of secondary importance because the transport of the application (e.g., which then contains the iDevID certificate) may be protected throughout via known encryption mechanisms (e.g., transport of the application instance via a TLS-protected communication channel).

As an extension to the device provisioning in accordance with OPC UA Part 21, the method provides that the software application trusts the IGDS (e.g., the internal registry instance) and is therefore allowed to carry out the certificate enrollment automatically without further authorization (e.g., manual authorization).

An Edge environment will want to establish that this is the correct application instance (e.g., OPC UA Part 21 will continue to be used in its intended form). In addition, the app verifies whether the device is also the one for which the application was purchased. This may also prevent an application from being purchased only once and then rolled out and used multiple times (e.g., on different devices).

The IGDS (310) of the OPC UA LDS Proxy (140) acts as registrar in relation to the application (200) with the OPC UA Server entity (UAS, 220) and performs the device provisioning with the application.

The result of this “software device provisioning” deployment method is the automated transfer of the correct application instance certificate (e.g., Device Configuration Application “Instance Certificate”) 132 for the application, which later provides the necessary trust relationship for the application 200.

The instance identification DCA provides that other functions of the application may be supplied with the necessary certificate material, if required (e.g., additional application instance certificates for OPC UA applications or server certificates for HTTPS servers).

This application instance certificate (e.g., DCA-Application Instance Certificate) may be used to automatically perform the provision of the communication certificate 132 (e.g., Application Instance Certificate Deployment) of the OPC UA application, as this certificate may be used as an authority confirmation for GDS authorization: the GDS application certificate and the DCA certificate are in a trust relationship with each other. As a result, the OPC UA server application (UAS, 220) trusts the GDS (311) and allows the transfer of the application instance certificate of the OPC UA server application 132. There is no need to manually configure an authentication authorized by the directory service GDS, since this authorization now takes place through the application instance certificate. The trust relationship is based on the deployment process that was carried out, in which service certificate 190 and device certificate (110) were used to verify mutual identity.

The result of the device provisioning was the issuance of the DCA certificate. For example, this may now have the same Root Certificate Authority CA as the certificate of the directory service GDS 311 and/or IGDS 300.

The trust relationship actually exists between the provision entity (e.g., by signing the service certificate and the associated device certificate with the provision entity CA certificate) and the Edge Host (e.g., runtime environment CA certificate).

The described method has two trust domains: the domain of the provision entity, service certificate 190 and device certificate 110; and the domain of the runtime environment (e.g., application instance certificate 191, internal registry entity REG, 310), which may then also include a system GDS (302) and other devices IED, 900.

In order to transfer the method originally intended for hardware components to software, obstacles are to be overcome (e.g., the protection of a private key, which is currently not possible in software: access “enclaves” enforced by a CPU hardware architecture are required, which are not supported in today's common virtualization architectures such as Docker). For the best possible protection, the current cryptographic methods are applied, and the application 200 is transferred via an encrypted data connection between the provision entity APS, 100 to the device Industrial Edge Device IED, 900. The service certificate is to be connected to its own application/service function by cryptographic functions, such that no separation or readout is possible. For example, in the environment of an Edge ecosystem assumed here, it may always be provided that the transport of the application instance from the provision entity 100 to the device 900 is securely encrypted.

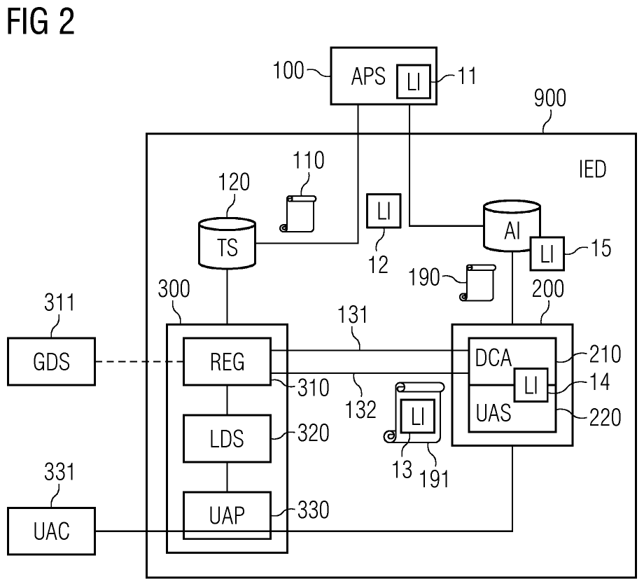

In a further embodiment, the method described above may be extended or used with a different objective, by adding license information LI, 11, . . . 15 to the service certificate and the device certificate. An example of this is shown in FIG. 2.

The procedure described above provides that the device certificate 110 and the application “married” to the service certificate are transferred to the device, IED 900 in a tamper-proof manner.

The license information LI may be appended to the device certificate as a user extension, for example. This extension does not affect the above-described provision method as such, but is to be seen as an addition.

The license information is transported via two information channels (e.g., device certificate and application deployment with service certificate) in order to implement different application scenarios, as explained below.

In an embodiment, the user buys an application (e.g., service) with a certain functionality (e.g., a license for twenty clients to establish a connection simultaneously).

No additional 3rd-party software library is then required for sale and deployment in the server (e.g., application); rather, the provision of the “runtime” licenses becomes part of the infrastructure already required for the certificate management for secure communication.

The license information 11 is contained in the service certificate 190 and/or the associated device certificate 110 and is stored on the Industrial Edge Device IED, 900 (e.g., transferred application instance AI, 201). As a result, the license information 15 is available in the application 200.

The (iDevID) service certificate and thus also the license information are classified by the internal registry entity as trusted using the device certificate 110 and are secured against tampering. After a successful validation of the certificates and establishment of the trust relationship between the internal registry entity REG 310 and the executed service instance 200, the device certificate and/or the license information LI contained therein is/are now transferred from the internal registry entity REG to the application, 131, 132. This then checks or uses the license information to validate the license information. For this to work, the device certificate and the service certificate are to have a common trust anchor (e.g., the same certificate-issuing provision entity 100) and the same biunique address.

For example, the address may be a ProductInstanceURI, the important thing being that it is a biunique identifier. OPC UA Part 21 places this requirement on a ProductInstanceURI. Other addresses, such as GUIDs, also work.

In a further embodiment, it is possible for the user to acquire a new license or to change an already acquired license for a service UAS (e.g., an increase in the number of permitted concurrent accesses by clients UAC). A new device certificate 110 with updated license information 11 is then created by the provision entity 100 and transferred to the Industrial Edge Device IED 900 on which the instance of the application 200 is running 12. The process of mutual recognition of the licenses between the application 200 and the central registry entity REG 310 is then carried out once again, and the license information in the application is therefore updated, 13, 14. Alternatively, it is also possible to initiate the mutual recognition process completely from scratch in order to generate a new application/service instance with a new (iDevID) service certificate 190 with updated license information as well as an associated device certificate 110, and transfer them to the device IED in a tamper-proof manner.

There are many different license models that may be implemented with this method: for example, depending on the number of clients, service users, duration of the service/application, memory size (database), or the functionality.

The OPC UA servers/service instances running on an Industrial Edge device with container system may be filled with valid certificates fully automatically using the method described here. In one embodiment, no further configuration steps are required compared to the known prior art than those that are already necessary for commissioning an Edge Host device and the provision entity.

The certificates to be issued are specifically designed not only for a single OPC UA server class, but for exactly one OPC UA server class instance on a specific Edge device, which increases the security of the proposed solution against counterfeiting and copying.

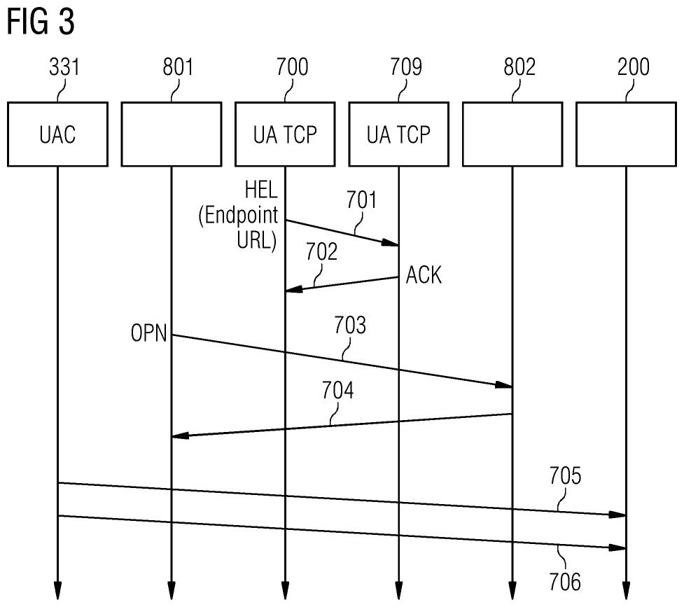

FIG. 3 illustrates the communication sequence at the beginning of the communication between the service user, client 331, and service provider, server 200. First, a channel is set up on OPC UA TCP level 701 (e.g., by querying HEL with the endpoint URL sought). In FIG. 3, this is the endpoint URL “visible” to the client from the outside (e.g., IP address of the container host plus port 4840 plus a path uniquely distinguishing the server, such as “/Server-A”). This request is confirmed by ACK 702.

An OPC UA Secure Channel is then set up between the two communication partners 801, 802, using OPN 703 and confirmation 704. Only then may service user 331 search for a suitable service provider 200, 705 and the correct addresses 706 (e.g., Endpoint). It is always important to note the problem that the service user always wants to access from the outside via the notorious port 4840, but this address does not match the internal address of the service (e.g., in the container).

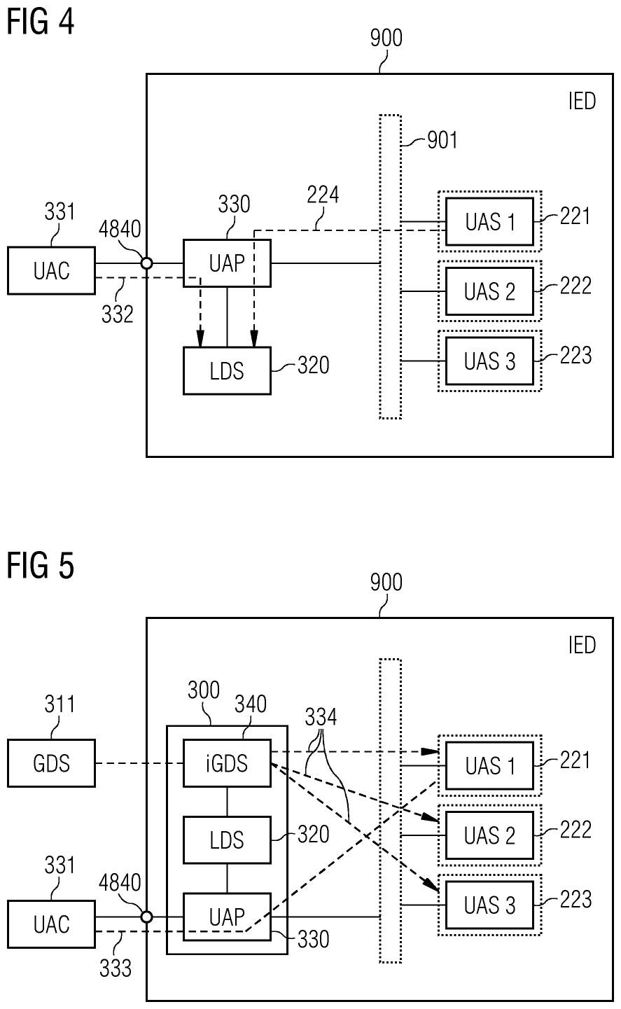

For further explanation, FIGS. 4 and 5 illustrate the same method for multiple service providers 221, 222, 223, which in the case illustrated, may be addressed via a host-internal container network, which serves to shield the containers 901. In FIG. 5, access is controlled via the global GDS and internal directory service IGDS, 333, 334.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for secure provision of a service on a device for execution on request by a service user, using a central provision entity, the method comprising:
assigning the service at least one server component in each case that is formed by a workflow control component that is loadable into a workflow control environment and executed in the workflow control environment;
providing a uniquely identifiable executable service instance of the service to the device;
supplying the service with and inseparably linked to a unique service certificate assigned to a service instance during the providing, so that the uniquely identifiable service instance is created; and
generating a device certificate that is also unique and associated with the unique service certificate, and transferring the device certificate to the device,
wherein the device identifies itself to the service with the device certificate, and the service verifies the device certificate using the unique service certificate,
wherein the device thus obtains authority to transmit to the service, in an application instance certificate, protected information required to continue to carry out the provision of the service,
wherein the unique service certificate, the device certificate, or the unique service certificate and the device certificate are supplemented with license information, and
wherein the license information determines the functionality of the service instance.

2. The method of claim 1, wherein device certificates assigned to the device are stored in a device certificate store on the device, the device certificates including the device certificate.

3. The method of claim 1, wherein the unique service certificate is an initial device identifier, generated in accordance with IEEE 802.1AR.

4. The method of claim 1, wherein additional functions of the service are suppliable with necessary certificates and information.

5. The method of claim 1, wherein the license information is appended to the device certificate as a user extension.

6. The method of claim 1, further comprising:
creating, in the central provision entity, a further device certificate with updated license information;
transferring the further device certificate to the device so that the functionality of the service instance of the application running on the device is changeable.

7. The method of claim 1, wherein when verifying the license information, the device certificate and the unique service certificate have a common certificate-issuing provision entity and a same biunique address.

8. A device for secure execution of a service provided by a central provision entity for execution on request by a service user, wherein the device has a uniquely identifiable executable instance of the service, wherein the uniquely identifiable executable instance of the service is assigned at least one server component in each case that is formed by a workflow control component that is loadable into a workflow control environment and executed at the workflow control environment, and an instance of the service is supplied with and inseparably linked to a unique service certificate assigned to the instance of the service during the provision, so that the uniquely identifiable service instance is created, the device comprising:
a processor configured to:
simultaneously receive a device certificate that is also unique and associated with the service certificate;
an internal registry entity configured to:
identify itself to the instance of the service with the associated device certificate; and
after verification by the service certificate, transfer an application instance certificate into the application, which contains protected information required to continue to carry out the provision of the service,
wherein the unique service certificate, the device certificate, or the unique service certificate and the device certificate are supplemented by license information, wherein the license information determines functionality of the service instance and is stored on the device in a dedicated license information store.

9. The device (of claim 8, further comprising a dedicated device certificate store configured to store the device.

10. The device of claim 8, wherein the internal registry entity is part of a directory service.

11. The device of claim 8, wherein the application instance is transported from the provision entity to the device via secure communication.

12. The device of claim 8, wherein the service certificate is an initial device identifier, generated in accordance with IEEE 802.1AR.

13. The method of claim 1, wherein the protected information required to continue to carry out the provision of the service includes correct address information.

14. The device of claim 8, wherein the protected information includes correct address information.

15. The device of claim 11, wherein the secure communication is via transport layer security (TLS).
